(19) United States
(12) Patent Application Publication
(10) Pub. No.: US 2007/0271020 A1
(43) Pub. Date: Nov. 22, 2007

(54) Motor vehicle speed detection and control system

(76) Inventors: Tony R. Flanner, Ovid, MI (US); Ronald L. Soper, Owosso, MI (US)

Correspondence Address: Raymond M. Galasso;Galasso & Associates LP, P.O. Box 26503, Austin, TX, 78755-0503, US

(21) Appl. No.: 11/728,680

(22) Filed: Mar. 26, 2007

Related U.S. Application Data
(60) Provisional application No. 60/801,981, filed on May 19, 2006.

(51) Int. Cl. G06F 17/00

(52) U.S. Cl. 701/93; 701/213

(57) ABSTRACT

A system disposed within a motor vehicle configured to measure the geographic coordinates of the vehicle in order to calculate and adjust and maintain the current speed of the vehicle to correspond to the speed limit the determined geographic coordinate. The system further includes a database that contains roadmaps and corresponding speed limit data. A coordinate determination system calculates the current geographic coordinate of the vehicle to calculate the current speed data of the vehicle and subsequently performs an algorithm to compare the current speed data with the speed limit data stored in the database for the current geographic coordinate. A speed adjusting mechanism will transmit a signal via an operating system interface to maintain the speed of the motor vehicle within a range corresponding to the speed limit data.

### PRIORITY UNDER 35 U.S.C. 119(e) & 37 C.F.R. 1.78

This nonprovisional application claims priority based upon the following prior United States provisional patent application entitled: Automatic vehicle govern speed control, Application No.: 60/801,981 filed May 19, 2006, in the name of Tony R. Flanner and Ronald L. Soper, which is hereby incorporated by reference for all purposes.

### FIELD OF THE INVENTION

The present invention relates to a speed control system, more specifically but not by way of limitation, a speed detection and control system that utilizes global positioning system data to determine the speed of the vehicle and subsequently reference the current speed with speed limit for a given location to accordingly adjust the speed of the vehicle.

### BACKGROUND

Millions of vehicles traverse our highway infrastructure every day. Approximately one hundred and fifteen people die in automobile accidents every day on our highways. Between 1990 and 2006 the number of vehicles that traverse our highways everyday increased by approximately forty percent. As the number of vehicles has increased on our highway systems so has the number of accidents.

One cause of the increase in the number of accidents is speed. Speeding is the number one cause of automobile accidents and fatalities every year. There are a plurality of reasons that cause drivers to inadvertently speed. Many drivers often become distracted by additional passengers in the vehicle or use of a cellular phone. Drivers can also become distracted by adjusting the radio or other device such as climate control in the vehicle. Many drivers do not practice safe driving techniques for treacherous road conditions caused by poor weather. While drivers can use current devices such as cruise control, these devices only maintain a preset speed inputted by the driver and do not have the ability to determine if that speed is within the speed limit. Furthermore, the current speed control systems do not possess any method of signaling to a driver if the speed that has been set exceeds the appropriate speed limit.

Accordingly there is a need for a speed control device for vehicles that has the ability to maintain the speed of a vehicle, measure the geographic location of the vehicle, and subsequently determine if the vehicle is traveling within the speed limit for its current location. Additionally, the system should further be able to warn the driver of the vehicle if an excessive speed is detected or be integrated to the vehicle to automatically control the speed in accordance with the known speed limit.

### SUMMARY OF THE INVENTION

It is the object of the present invention to provide a method of speed detection and control for a vehicle that utilizes global positioning system signals in conjunction with a reference database to measure the vehicle's current rate of speed and location in order to subsequently determine if the vehicle is traveling at the appropriate rate of speed for the given location.

A further object of the present invention is to provide a method speed detection and control of a vehicle that provides a warning signal to the driver of the vehicle when the appropriate speed limit has been exceeded.

Yet another object of the present invention is to provide a method of speed detection and control of a vehicle that functions to automatically control the speed of the vehicle if the vehicle is not traveling at the appropriate speed for a given location.

Another object of the present invention is to provide a method of speed detection and control of a vehicle that is relatively inexpensive and easy to use.

To the accomplishment of the above and related objects the present invention may be embodied in the form illustrated in the accompanying drawing. Attention is called to the fact that the drawing is illustrative only. Variations are contemplated as being a part of the present invention, limited only by the scope of the claims.

### BRIEF DESCRIPTION OF THE DRAWING

A more complete understanding of the present invention may be had by reference to the following Detailed Description and appended claims when taken in conjunction with the accompanying Drawing wherein:

FIG. 1 illustrated a preferred embodiment of the present invention.

### DETAILED DESCRIPTION

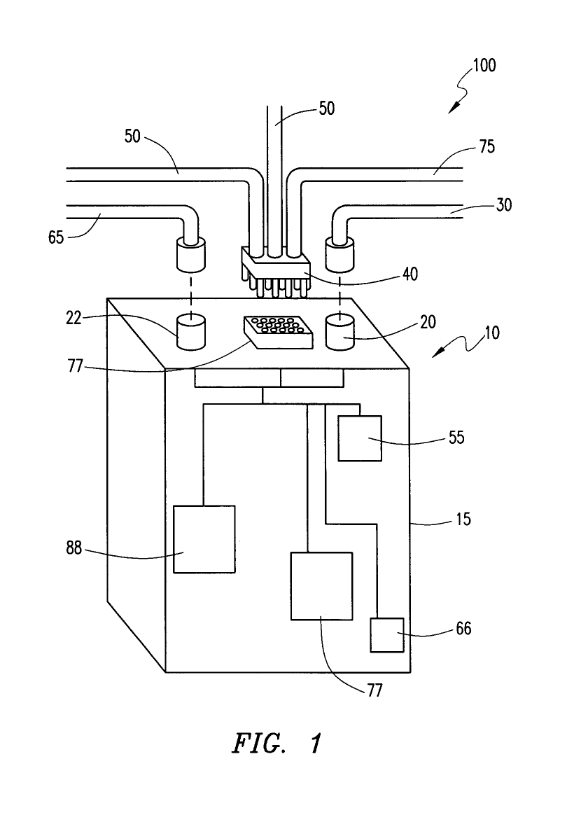

Referring now to the drawing submitted herewith wherein the various elements depicted therein are not necessarily drawn to scale and in particular to FIG. 1, there is illustrated a preferred embodiment of a speed control system 100 constructed according to the principles of the present invention.

The speed control system 100 comprises a controller 10 that is disposed within a housing 15. The controller 10 is secured within a motor vehicle such as but not limited to an automobile or truck. The housing 15 is manufactured from a suitable durable material such as but not limited to plastic. As can be appreciated by those ordinarily skilled in the art, controller 10 contains electronics, circuitry and microprocessors that function to receive, store and manipulate data.

As illustrated controller 10 includes a coordinate determination unit 55, a data base 66, a speed adjustment device 77, and a power controller 88.

Coordinate determination unit 55 is utilized to determine the geographic coordinates of the vehicle, such as a global positioning system (GPS) unit. Coordinate determination unit 55 is connected to terminal 20. Terminal 20 is configured to receive a connection for an antenna, such as a typical GPS antenna. As is known, GPS units utilize a plurality of satellite signals to calculate a position and determine the current geographic coordinates of the device. The coordinate determination unit 55 receives the satellite signals and identifies its current location. This information is received and processed in a continuous manner. Those skilled in the art will recognize that conventional GPS units can provide several categories of information such as but not limited to how far the vehicle has traveled, the current speed, the average speed, and how long the vehicle has been traveling.

Database 66 includes data corresponding to roadmaps of specific locations, such as a roadmap of the United States. Additionally, database 66 contains the speed limit data corresponding to all roads contained in the roadmap. The coordinate determination unit 55 functions to receive the satellite signals in order to calculate the current geographic coordinate location of the vehicle and its current speed. This data is then cross-referenced to the database 66 containing therein the roadmap and speed limit data. The necessary algorithms are used to compare the current speed information against the speed limit data contained within the database of roadmap and speed limit information.

Subsequent to comparison of this data, the speed adjustment mechanism 77 functions to transmit a signal to an operating system of the vehicle such as the fuel control system or a conventional cruise control system to maintain the speed of the vehicle corresponding to the speed limit data for that particular geographic coordinate location. It should be recognized that the speed control system 100 is operably connected to the vehicle in order to regulate the speed of the vehicle in a positive or negative direction. It is desired within the scope of the present invention that the speed control system 100 mediate the speed of the vehicle to be approximately equivalent to the speed limit data as recorded within the database or within a preset speed range of the speed limit data as recorded within the database. This process functions in a continuous loop during activation of the speed control system 100.

The speed control system 100 is manually activated or deactivated with the power controller 88 as desired by the driver of the vehicle in which the speed control system 100 is disposed and operably connected. The power controller 88 is electrically coupled to the power supply interface 50 that is operably engaged with the power system of the motor vehicle. While no particular power system is required, good results have been achieved by utilizing a twelve volt direct current power system conventional in most vehicles. It is contemplated that the driver will activate the speed control system 100 when traffic conditions and other factors such as but not limited to weather permit.

It is further contemplated within the scope of the present invention that the speed control system 100 could be activated remotely by a central command system that functions to monitor a plurality of vehicles in which the speed control system 100 is mounted therein. This would allow a remote monitoring organization to monitor and/or control the speed of the vehicle in the instance that the vehicle is traveling greater than a predetermined speed limit for a sustained time period.

Superposed on the housing 15 adjacent to the terminal 20 is a connector plug 40. The connector 40 is electrically coupled to the receptacle 70. The connector plug 40 functions to operably couple the controller 40 to a plurality of systems in the vehicle. The operating system interface 75 is secured to the connector plug 75. The operating system interface 75 functions to electrically couple the speed adjusting mechanism 77 and the operating systems of the vehicle that regulate speed such as the fuel flow system or the cruise control system. The operating system interface 75 includes conventional materials such as but not limited to insulated wire.

The power supply interface 50 is secured to the connector plug 40 and function to provide the necessary power required to operate the controller 10. While no specific voltage is required, it is contemplated within the scope of the present invention that the controller 10 is electrically engaged with the twelve volt electrical system of the vehicle with the power supply interface 50. The power supply interface 50 is manufactured from conventional materials such as but not limited to insulated wire.

Superposed on the housing 15, adjacent to the connector plug 40 opposite the terminal 20 is the video output terminal 22. The video output terminal 22 functions to transmit the required signals to a display device that will display various information from the controller 10 such as an image of the roadmap, the current position of the vehicle, the speed, average speed, and traveling time. The monitor interface 65 functions to electrically couple the controller 10 to a display device and transmit the necessary signals to operate the display device. It is contemplated within the scope of the present invention that the speed control system 100 be operably connected to the vehicle without the need for a display device.

It is further contemplated within the scope of the present invention that the speed control system 100 contain a plurality of sensors that function to monitor and record positional data of objects, such as but not limited to other vehicles, adjacent to the vehicle in which the speed control system 100 is secured therein. The speed control system 100 would process this positional data of adjacent objects in the necessary algorithm prior to transmitting the necessary signal to adjust the speed of the vehicle via the operating system interface.

Referring in particular to FIG. 1, a description of the operation of the speed control system 100 is as follows. In use, a user will mount the speed control system 100 into a desired vehicle and operably connect the speed control system 100 thereto. The driver of the vehicle activates the speed control system 100 when desired and conditions permit via the power controller 88. Subsequent to activation, the speed control system 100 receives the necessary signals to determine the geographic coordinates of the vehicle utilizing the coordinate determination unit 55. The geographic coordinate information is received and processed in a continuous manner such that the speed control system 100 utilizes that data in the necessary algorithm to calculate the current speed of the vehicle. The current speed information is cross-referenced to the database 66 containing therein the roadmap and speed limit data. Following the determination of the current speed, location and speed limit allowed for the current location of the vehicle, the speed adjustment mechanism 77 will adjust the speed of the vehicle by transmitting the required signals via the operating system interface 75. A speed adjustment to the vehicle can be generated when the vehicle is exceeding or below the a predetermined range of the desired speed limit. The conditions under which a signal to adjust the speed of the vehicle is stored in the controller 10 which has been inputted by the user or other individual. This speed adjustment process functions in a continuous manner during activation of the speed control system.

In the preceding detailed description, reference has been made to the accompanying drawing that forms a part hereof, and in which is shown by way of illustration specific embodiment in which the invention may be practiced. This embodiment, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A system operable to adjust the speed of a motor vehicle, comprising:
a geographic coordinate determination system operable to receive data and determine the geographic coordinate of the motor vehicle; and
a speed control unit operable to maintain the speed of the motor vehicle pursuant to the determined geographic coordinate of the motor vehicle.

2. The system as recited in claim 1, and further including a database, said database having contained therein a plurality of roadmaps with corresponding speed limits data.

3. The system as recited in claim 2, wherein said geographic coordinate determination system interfaces with said database to determine the speed limit of the location of geographic coordinate of the motor vehicle.

4. The system as recited in claim 3, wherein said speed control interfaces with said geographic coordinate determination system and said database to maintain the speed of the motor vehicle within a range of speed from the speed limit of the location of the geographic coordinate of the motor vehicle.

5. The system as recited in claim 4, wherein said geographic coordinate determination system includes a global positioning system.

6. The system as recited in claim 5, wherein said system is electrically coupled to the power supply of the motor vehicle.

7. A device for a motor vehicle, comprising:
a global positioning system (GPS), said GPS operable to determine the geographic location of the motor vehicle; and
a speed control unit operable to control the speed of the motor vehicle in response to the determined geographic location of the motor vehicle.

8. The device as recited in claim 7, and further including a database, said database having stored therein a plurality of roadmaps with corresponding speed limit data.

9. The device as recited in claim 8, wherein said GPS is further operable to calculate the current speed of the motor vehicle.

10. The device as recited in claim 9, wherein said speed control unit is further operable to control the speed of the motor vehicle within a predetermined range of speed corresponding to the speed limit data of the determined geographic location of the motor vehicle.

11. The device as recited in claim 10, wherein said speed control unit is operable to decrease the speed of the motor vehicle in response to the calculated speed of the motor vehicle being great than a predetermined limit of the speed limit data of the determined geographic location.

12. The device as recited in claim 11, wherein the speed control unit is operably coupled to at least one of a fuel flow system and a cruise control system of the motor vehicle.

13. A system operable to control the speed of a vehicle utilizing the geographic coordinates of the vehicle comprising:
a controller, said controller configured to receive, store and manipulate data, said controller being operably connected to the motor vehicle, said controller being disposed within the motor vehicle;
a global positioning system, said global positioning system operably connected to said system, said global positioning system configured to receive and store geographic coordinates;
a speed control unit; said speed control unit operably coupled to the motor vehicle to adjust the speed of the motor vehicle; and
a database, said database having stored therein a plurality of roadmaps and speed limit data for all geographic coordinates along the roadmaps.

14. The system as recited in claim 13, wherein the global positioning system is configured to calculate, store and transmit the current speed data of the vehicle.

15. The system as recited in claim 14, wherein the speed control unit processes the current speed data from the global positioning system and performs an algorithm to compare the current speed data with the speed limit data contained in said database for the current geographic coordinate.

16. The system as recited in claim 15, and further including an operating system interface operably coupled to at least one of the fuel control systems or cruise control systems of the vehicle.

17. The system as recited in claim 16, wherein the speed control unit transmits a signal to adjust the speed of the vehicle is the current speed data is different from the speed limit data for the geographic coordinate.

18. The system as recited in claim 17, wherein the speed control unit functions to adjust the speed of the vehicle when the current speed data is greater than the speed limit data for the geographic coordinate.

19. The system as recited in claim 18, wherein said system is electrically coupled to the power supply of the vehicle.

20. The system as recited in claim 19, wherein said system is further configured to transmit current speed data and speed limit data to a remote monitor.
